(19) United States
(12) Patent Application Publication
(10) Pub. No.: US 2008/0176057 A1
(43) Pub. Date: Jul. 24, 2008

(54) Inorganic board and method for producing the same

(75) Inventor: Masanori Ukai, Nagoya-Shi (JP)

Correspondence Address: BIRCH STEWART KOLASCH & BIRCH, PO BOX 747, FALLS CHURCH, VA, 22040-0747, US

(73) Assignee: NICHIHA CORPORATION, Nagoya-Shi (JP)

(21) Appl. No.: 11/907,815

(22) Filed: Oct. 17, 2007

(30) Foreign Application Priority Data
Oct. 19, 2006 (JP) JP2006-285427

(51) Int. Cl. B32B 13/02; B32B 37/14

(52) U.S. Cl. 428/292.4; 428/294.7; 428/293.4; 428/292.7; 264/171.1

(57) ABSTRACT

An object of the invention is to provide an inorganic board excellent in water absorption resistance, dimensional stability and/or frost damage resistance, and a method for producing the same. The inorganic board is produced through the following processes: preparing a slurry by dispersing a cement-based hydraulic material and a refined fiber reinforcing material into water, adding a saturated carboxylic acid to the slurry, and then the slurry is subjected to the steps of sheetmaking, dehydration, pressing and curing. The inorganic board comprising a refined fiber reinforcing material at 1-30 weight % based on the total solid content and a saturated carboxylic acid at 0.1-2.0% based on the total solid content.

This non-provisional application claims priority under 35 U.S.C. 119(a)-(d) on Application No. 2006-285427 filed in Japan on Oct. 19, 2006.

### FIELD OF THE INVENTION

The present invention relates to an inorganic board excellent in water absorption resistance, dimensional stability and/or frost damage resistance, and a method for producing the same.

### BACKGROUND OF THE INVENTION

Inorganic boards have been widely used for building materials such as a wall material or a roofing material. The inorganic boards have been required to show good performance with respect to constructability, dimensional stability, frost damage resistance and weather resistance, in addition to strength, water resistance and fire resistance. As one of the ways to meet such requirements, there is a method for producing an inorganic board which comprises the steps of: mixing a cement, a siliceous raw material such as silica sand or silica fume, a pozzolana material such as blast-furnace slag or fly ash, and a reinforcing fiber material such as pulp fiber with water; agitating the mixture to form a slurry; molding the slurry; curing the molded material; and then various coatings are applied onto the front and the back surfaces. Since an inorganic board, however, includes a cement and a fiber reinforcing material as raw materials, dimensional change may be caused by the calcium hydrate and/or the reinforcing fiber material. Also an inorganic board has a lot of pores inside. If there is water in the pores, carbon dioxide in the air is dissolved into the water to form carbonic acid which reacts with a calcium hydrate in the board to cause dimensional shrinkage called carbonation shrinkage. These problems can be caused even in an inorganic board having coatings on its front and back surfaces.

To avoid these problems, there is a method where an inorganic board after molding is cured in an autoclave, and then various coatings are applied onto the front and back surfaces.

There is another method where an emulsion of a water-repellent agent such as a paraffin is mixed with the slurry for improved moldability, and then the steps of dehydration, molding, curing and coating are performed.

Patent reference JP61-026545A further discloses another method wherein a water-repellent agent such as paraffin is adsorbed on a raw material of natural or artificial zeolite, then the paraffin adsorbed zeolite is blended with a hydraulic inorganic raw material such as cement. An aggregate forms uniformly, and water is added to the mixture so that the water-added mixture is molded in a predetermined shape and then cured.

Using autoclave curing, however, needs large sized equipment, and as such, there is a requirement for a substantial initial investment and land space.

In the method where a water-repellent agent such as paraffin is added to and mixed with a slurry of the molding material, it is difficult for the water-repellent to be dispersed uniformly because of surfacing of the repellent and/or foaming occurring during the process. In addition to that, the repellent agent is drained with the water during the dehydration step. Therefore, less amounts of repellent remain inside the base material, which makes it difficult to effect the repellent function. If a large amount of repellent agent is used, curing is inhibited.

The method described in JP61-026545A is effective when preparing an inorganic board using natural or artificial zeolite, but it cannot applied to an inorganic board which does not contain natural or artificial zeolite. Also, extra equipment is needed for preparing the natural or artificial zeolite with an adsorbed water-repellent agent.

### BRIEF SUMMARY OF THE INVENTION

An object of the present invention is to provide an inorganic board excellent in water absorption resistance, dimensional stability and/or frost damage resistance, and a method for producing the same. This object is accomplished with the following embodiments of the invention.

In an embodiment of the invention is an inorganic board comprising; a cement-based hydraulic material, a refined fiber reinforcing material, and a saturated carboxylic acid. As a cement-based hydraulic material, for example, Portland cement, mixed cement, eco-cement, low heat cement, and alumina cement can be used. As a refined fiber reinforcing material, wood fiber such as waste paper, wood pulp, wood fiber bundle, wood fiber, wood chip, wood wool, wood flour; inorganic fiber such as glass fiber, carbon fiber; and organic fiber such as polyamide fiber, wollastonite, polypropylene fiber, polyvinyl alcohol fiber, polyester fiber and polyethylene fiber can be used. It is preferable to use a wood pulp and more preferable to use a softwood unbleached kraft pulp (NUKP), a softwood bleached kraft pulp (NBKP), a hardwood unbleached kraft pulp (LUKP) and a hardwood bleached kraft pulp (LBKP). It is most preferred to use a softwood pulp such as (NUKP) or (NBKP).

As part of the invention, the wood fiber comprises refined fiber. As for refining, there is no particular limitation. However, refining with a refiner such as a disk refiner is preferable and to use freeness of 650 ml or less is more preferable. It is also preferable to use a combination of a refined fiber reinforcing material and a unrefined fiber reinforcing material in consideration of cost and productivity. Freeness is a value defined by Canadian Standard Measuring method (Canadian Standard Freeness) and is a measure of drainability of the pulp. As a saturated carboxylic acid, lauric acid-based, caproic acid-based, propionic acid, stearic acid-based, succinic acid-based and the like can be used.

In an embodiment of the invention, the refined fiber reinforcing material accounts for 1 weight % to 30 weight % based on the total solid content. This inorganic board is less expensive in terms of raw materials and has appropriate values of specific gravity, strength and flexibility, which provide excellent constructability. If the refined fiber reinforcing material accounts for less than 1 weight %, the specific gravity becomes high and flexibility disappears, which provides poor constructability. If the refined fiber reinforcing material accounts for more than 30 weight %, the percentage of cement-based hydraulic material becomes low and an inhibiting hardening ingredient eluted from the refined fiber reinforcing material increases, which lowers the strength of the inorganic board and increases the cost of the raw material. In consideration of cost performance, it is preferable to use a refined fiber reinforcing material of 3-11 weight % and an unrefined fiber reinforcing material of 4-14 weight % in combination based on the total solid content.

In an embodiment of the invention, the saturated carboxylic acid accounts for 0.1 weight % to 2.0 weight % based on the total solid content. This inorganic board is excellent in water absorption resistance, dimensional stability and/or frost damage resistance. If the saturated carboxylic acid accounts for less than 0.1 weight %, sufficient properties of water absorption resistance, dimensional stability and/or frost damage resistance are not realized. If the saturated carboxylic acid accounts for more than 2.0 weight %, hardening of cement-based hydraulic material is inhibited, which leads to low strength of the board. In consideration of cost performance, it is preferable to use a saturated carboxylic acid of 0.3 weight % to 1.0 weight % based on the total solid content.

In an embodiment of the invention, the saturated carboxylic acid is a stearic acid-based carboxylic acid or a succinic acid-based carboxylic acid. As a saturated carboxylic acid, although many types such as lauric acid-based, caproic acid-based, propionic acid can be used, it is particularly preferred to use a stearic acid-based or succinic acid-based carboxylic acid because of the high effects.

In an embodiment of the invention, is a method for producing an inorganic board comprising the steps of:

preparing a slurry by dispersing a cement-based hydraulic material and a refined fiber reinforcing material into water, adding a saturated carboxylic acid to the slurry, and then the slurry is subjected to a sheetmaking step, dehydration step, pressing step and curing step. By adding a saturated carboxylic acid to a slurry made by dispersing a cement-based hydraulic material and a refined fiber reinforcing material into water, the saturated carboxylic acid can be uniformly dispersed to make a calcium hydrate and the refined fiber reinforcing material be coated with the carboxylic acid. This calcium hydrate coated with the saturated carboxylic acid and the saturated carboxylic acid itself are captured on the refined fiber reinforcing material. Therefore, loss of the carboxylic acid by draining together with water during the dehydration step can be suppressed. In other words, the saturated carboxylic acid will stay in the inorganic board as a coating on the calcium hydrate and refined fiber reinforcing material.

In an embodiment of the invention, the saturated carboxylic acid used for producing the inorganic board is a stearic acid-based carboxylic acid or a succinic acid-based carboxylic acid. As a saturated carboxylic acid, although many types such as lauric acid-based, caproic acid-based, propionic acid can be used, it is particularly preferred to use a stearic acid-based or succinic acid-based carboxylic acid because of the high effects.

In the inorganic board of the present invention, a calcium hydrate and a fiber reinforcing material are coated with a saturated carboxylic acid. Consequently water absorption, dimensional change and/or carbonation shrinkage can be suppressed, and water absorption resistance, dimensional stability and/or frost damage resistance can be secured for a long time.

Also, the inventive process can be easily carried out if a refiner for a fiber reinforcing material and a device for adding a saturated carboxylic acid to a slurry are available. Since the method does not need a large facility, an initial investment and running costs can be very small in addition to its simple operation.

Further, as the saturated carboxylic acid is captured by a refined fiber reinforcing material in the present invention, surfacing of the water-repellent agent and/or foaming can be prevented, and yet a small amount of carboxylic acid can work well.

This invention can be broadly applied to other methods in addition to the sheetmaking method, for example, an extrusion molding method or a casting method in which a slurry is molded in a mold.

### DETAILED DESCRIPTION OF THE INVENTION

Preferred embodiments of the inorganic board of the present invention and the method for producing the same are described below.

First, a raw material is prepared by blending the following materials and dispersing them into water: a cement-based hydraulic material (such as Portland cement) ranging from 20 weight % to 75 weight %, a wood pulp as a refined fiber reinforcing material with freeness of 650 ml or less of 12 weight %, a wood pulp as unrefined fiber reinforcing material of 6 weight %, and further when needed, perlite, silica sand, silica, Shirasu balloon, vermiculite, blast-furnace slag, an expansive shale, an expansive clay, calcined diatomaceous earth, gypsum powder, mica, fly ash, coal cinder, and/or sludge incinerated ash, wherein the weight % is based on the weight of the raw material.

The reason why a refined wood pulp with freeness of 650 ml or less is used is described below. A refined wood pulp with freeness of 650 ml or less can be easily and uniformly dispersed into the slurry. In addition, the configuration of such a refined wood pulp is suitable for adsorbing and capturing substances. A fiber reinforcing material such as pulp is a bundle made of a number of fibrils (micro fibers). The fibrils are normally tied in a bundle by hydrogen bonding or intermolecular forces and when refined under wet conditions, the fibrils are torn along an air groove between fibrils to make the fiber reinforcing material finer so as to be uniformly dispersed into the slurry. The friction caused by refining makes the fibrils located at the inner part of the bundles come out to the surface of the bundle, which causes the surface of the fiber reinforcing material to be raised and finely split. Particularly under wet conditions, fibrils come out like whiskers, which increases the specific surface area and makes the configuration suitable for adsorbing and capturing substances, that is, suitable for holding a raw material such as a cement-based hydraulic material, a saturated carboxylic acid and the like. As a result, the raw material such as a cement-based hydraulic material, a saturated carboxylic acid and the like is prevented from being drained with the water that is removed during the dehydration process. A refined wood pulp with freeness of 500 ml or less is more preferable since the configuration becomes more capable of adsorbing and capturing substances. Also the refined wood pulp with freeness of 650 ml or less provides other advantages such as the strength of the fiber is increased and a network tennds to be made between the fibers, which increases the strength of organic board to be produced. It is preferable to use a combination of a refined fiber reinforcing material and an unrefined fiber reinforcing material in consideration of cost and productivity.

Then, a carboxylic acid-based emilsion solution, specifically stearic acid-based or succinic acid-based emulsion solution is added to the above slurry so that a solid content of the emulsion accounts for 1 weight % of less of toatal solid content of the slurry. After agitating, the slurry is cast onto a dehydrated felt to form a wet sheet. After the wet sheet has been dehydrated, the wet sheet is piled up using a making roll so as to form a laminated mat with 6-15 layers. The laminated mat undergoes a primary cure wherein it is pressed at pressures of 1.5 MPa-10 MPa, then cured at 60-90° C. for 5-10 hours. When needed, steam curing or curing in an autoclave is further carried out. Steam curing is carried out at 50-80° C. for 15-24 hours in a steam-filled atmosphere, whereas autoclave curing is carried out at 120-200° C. for 7-15 hours. After curing, the mat is dried and if needed, coatings are applied to a front surface, a rear surface and a butt end surface, to form the product.

The reason why a stearic acid-based or succinic acid-based emulsion solution is used is because of its water-repellent efect, good dispersion into water and capability of being coated on a calcium hydrate and a refined fiber reinforcing material. The stearic acid-based or succunic acid-based emulsion solution is uniformly dispersed in the slurry and coated on the calcium hydrate of cement-based hydraulic material and on the refined fiber reinforcing material, which prevents the calcium hydrate of inorganic board from absorbing water and being carbonated, and prevents the refined fiber reinforcing material from absorbing water. Therefore, in the organic board, water absorption resistance, dimensional stability and frost damage resistance can be improved. Further the calcium hydrate coated therewith is captured by the refined fiber reinforcing material, consequently the calcium hydrate coated therewith is prevented from being drained with the water which is removed during the dehydration process. This makes it possible to secure water absorption resistance, dimensional stability and frost damage resistance of the inorganic board for a long time.

### EXAMPLES

Various inorganic boards were produced according to the following conditions as shown in Examples 1-8 and Comparison Examples 1-7.

### Example 1

Raw material containing the following materials is dispersed into water to make a raw material slurry; i.e., 30 weight % of Portland cement, 10 weight % of refined wood pulp with freeness of 500 ml, 10 weight % of perlite and 50 weight % of blast furnace slag and fly ash wherein the weight % is based on the weight of the raw material. A stearic acid emulsion solution is added to the above slurry so that the stearic acid accounts for 0.5 weight % of total solid content of the slurry. After agitating, the slurry is cast onto a dehydrating felt to form a wet sheet. After dehydration, the wet sheet is piled up using a making roll so as to form a laminated mat with 6 layers. The laminated mat is pressed by high-pressing of 2.0 MPa for 7 seconds, then cured by steam at 70° C. and dried to form an inorganic board.

### Example 2

A stearic acid emulsion solution is added to the same raw material slurry as in Example 1 so that the stearic acid accounts for 1.0 weight % based on the total solid content of the slurry. After agitating, the same method of forming a wet sheet, dehydrating, pressing and hardening/curing as was used in Example 1 were carried out for producing an inorganic board. The stearic acid-based emulsion solution and refined fiber reinforcing material were also the same as those in Example 1.

### Example 3

A stearic acid emulsion solution is added to the same raw material slurry as in Example 1 so that the stearic acid accounts for 2.0 weight % based on the total solid content of the slurry. After agitating, the same method of forming a wet sheet, dehydrating, pressing, and hardening/curing as were used in Example 1 were carried out for producing an inorganic board. The stearic acid emulsion solution and refined fiber reinforcing material were also the same as those in Example 1.

### Example 4

An inorganic board was produced in the same way as Example 3 except that the refined wood pulp with freeness of 500 ml in Example 3 was replaced with a mixture of the refined wood pulp with freeness of 500 ml and an unrefined wood pulp with freeness of 780 ml wherein the solid content of the refined wood pulp is equal to that of unrefined wood pulp. The percentage of wood pulp based on the total solid content is the same as in Example 3.

### Example 5

A succinic acid emulsion solution is added to the same raw material slurry as in Example 1 so that the succinic acid accounts for 0.5 weight % based on the total solid content of the slurry. After agitating, the same method of forming a wet sheet, dehydrating, pressing and hardening/curing as were used in Example 1 were carried out for producing an inorganic board. The refined fiber reinforcing material was also the same as one in Example 1.

### Example 6

A succinic acid emulsion solution is added to the same raw material slurry as in Example 1 so that the succinic acid accounts for 1.0 weight % based on the total solid content of the slurry. After agitating, the same method of forming a wet sheet, dehydrating, pressing and hardening/curing as were used in Example 1 were carried out for producing an inorganic board. The refined fiber reinforcing material was also the same as those in Example 1.

### Example 7

A succinic acid emulsion solution is added to the same raw material slurry as in Example 1 so that the succinic acid accounts for 2.0 weight % based on the total solid content of the slurry. After agitating, the same method of forming a wet sheet, dehydrating, pressing and hardening/curing as those were in Example 1 were carried out for producing an inorganic board. The refined fiber reinforcing material was also the same as those in Example 1.

### Example 8

An inorganic board was produced in the same way as Example 7 except that the refined wood pulp with freeness of 500 ml in Example 7 was replaced with a mixture of the refined wood pulp with freeness of 500 ml and an unrefined wood pulp with freeness of 780 ml, wherein the solid content of the refined wood pulp was equal to that of unrefined wood pulp. The percentage of wood pulp to total solid content was the same as in Example 7.

### Comparison Example 1

Example 1 was repeated except that carboxylic acid emulsion solution was not added to the same raw material slurry as in Example 1. After agitating, the same method of forming a wet sheet, dehydrating, pressing and hardening/curing as those were in Example 1 were carried out for producing an inorganic board. The refined fiber reinforcing material was also the same as those in Example 1.

### Comparison Example 2

A stearic acid emulsion solution is added to the same raw material slurry as in Example 1 so that the stearic acid accounts for 3.0 weight % based on the total solid content of the slurry. After agitating, the same method of forming a wet sheet, dehydrating, pressing and hardening/curing as those were in Example 1 were carried out for producing an inorganic board. The stearic acid emulsion solution and refined fiber reinforcing material were also the same as those in Example 1.

### Comparison Example 3

An inorganic board was produced in the same way as Example 1 except that the refined wood pulp with freeness of 500 ml in Example 1 was replaced with an unrefined wood pulp with freeness of 780 ml. The stearic acid emulsion solution was also the same as those in Example 1.

### Comparison Example 4

A succinic acid emulsion solution is added to the same raw material slurry as in Example 1 so that the succinic acid accounts for 3.0 weight % based on the total solid content of the slurry. After agitating, the same method of forming a wet sheet, dehydrating, pressing and hardening/curing as those were in Example 1 were carried out for producing an inorganic board. The refined fiber reinforcing material was also the same as those in Example 1.

### Comparison Example 5

An inorganic board was produced in the same way as Example 5 except that the refined wood pulp with freeness of 500 ml in Example 1 was replaced with an unrefined wood pulp with freeness of 780 ml. The succinic acid emulsion solution was also the same as those in Example 5.

### Comparison Example 6

A paraffin solution is added to the same raw material slurry as in Example 1 so that the paraffin accounts for 1.0 weight % based on the total solid content of the slurry. After agitating, the same method of forming a wet sheet and dehydrating as those used in Example 1 were carried out. The refined fiber reinforcing material was also the same as in Example 1.

### Comparison Example 7

A silicone emulsion solution is added to the same raw material slurry as in Example 1 so that the silicone accounts for 1.0 weight % based on the total solid content of the slurry. After agitating, the same method of forming a wet sheet and dehydrating as those used in Example 1 were carried out. The refined fiber reinforcing material was also the same as in Example 1.

With respect to each inorganic board of Examples 1-8 and Comparison Examples 1-7, the following items were measured; thickness, specific gravity, moisture content, bending strength, Young's modulus in flexure, maximum amount of deflection, amount of surface water absorption, elongation percentage by water absorption, shrinkage percentage by releasing moisture, carbonation shrinkage percentage, and freezing thawing resistance. The results are shown in Table 1.

Bending strength, Young's modulus in flexure and maximum amount of deflection were measured using a test piece of 500 mm×400 mm pursuant to JIS A 1408. The amount of surface water absorption was measured using a frame method and is represented by the weight change of the inorganic board defined by the following Expression 1.

{weight (g) after measuring (after 24 hours)−initial weight (g)}/0.2×0.2 (area in the frame: m²) Expression (1)

Elongation percentage by water absorption is defined as the percentage of elongation of the board in which water is absorbed after being exposed to humid conditions at 60° C. for 3 days and then being soaked in water for 8 days.

Shrinkage percentage by releasing moisture is defined as the percentage of dimensional shrinkage of the board after releasing moisture by having humidity conditioning at 60° C. and 60% RH for 10 days and then being dried at 80° C. for 10 days.

Carbonation shrinkage percentage is defined as the percentage of dimensional shrinkage of the board after being exposed to 5% CO2 for 7 days and then being dried at 80° C. for 10 days.

Freezing thawing resistance is defined as the percentage of thickness swelling of the board after undergoing 30 cycles, wherein during each cycle the board is soaked in water and undergoes processes of 12 hours freezing in a container followed by 12 hours thawing at room temperature.

TABLE 1

| | | | Examples | | | | | | | |
|---|---|---|---|---|---|---|---|---|---|---|
| | | unit | 1 | 2 | 3 | 4 | 5 | 6 | 7 | 8 |
| Saturated | Items | | Stearic acid | | | | Succinic acid | | | |
| Carboxylic | Content | % | 0.5 | 1.0 | 2.0 | 2.0 | 0.5 | 1.0 | 2.0 | 2.0 |
| acid | (in terms of solid | | | | | | | | | |
| | content) | | | | | | | | | |
| Wood | Freeness | ml | 500 | | | 500 and | 500 | | | 500 |
| pulp | | | | | | 780 | | | | and |
| | | | | | | | | | | 780 |
| Physical | Thickness | mm | 11.9 | 12.0 | 11.8 | 11.9 | 11.9 | 11.7 | 12.1 | 12.0 |
| Property | Specific gravity | | 0.94 | 0.95 | 0.92 | 0.93 | 0.93 | 0.94 | 0.88 | 0.91 |
| of board | Moisture content | % | 8.7 | 9.4 | 8.1 | 8.5 | 8.4 | 8.6 | 7.2 | 8.0 |
| | Bending strength | N/mm² | 13.8 | 13.6 | 13.5 | 13.1 | 13.4 | 13.1 | 12.2 | 13.0 |
| | Young's modulus | kN/mm² | 3.7 | 3.8 | 3.4 | 2.9 | 3.4 | 3.5 | 2.7 | 3.2 |
| | in flexure | | | | | | | | | |
| | Maximum amount | mm | 12.6 | 11.9 | 13.4 | 12.9 | 13.1 | 12.7 | 18.4 | 15.1 |
| | of deflection | | | | | | | | | |
| | Amount of surface | g/m² | 2,200 | 1,950 | 1,230 | 1,510 | 1,820 | 1,420 | 1,140 | 1,210 |
| | water absorption | | | | | | | | | |
| | Elongation | % | 0.11 | 0.09 | 0.09 | 0.09 | 0.09 | 0.07 | 0.07 | 0.07 |
| | percentage by | | | | | | | | | |
| | water absorption | | | | | | | | | |
| | Shrinkage | % | 0.26 | 0.27 | 0.26 | 0.26 | 0.24 | 0.26 | 0.27 | 0.27 |
| | percentage by | | | | | | | | | |
| | releasing moisture | | | | | | | | | |
| | Carbonation | % | 0.09 | 0.07 | 0.04 | 0.05 | 0.09 | 0.06 | 0.07 | 0.07 |
| | shrinkage | | | | | | | | | |
| | percentage | | | | | | | | | |
| | Freezing thawing | % | 3.2 | 2.8 | 2.1 | 2.5 | 4.8 | 3.4 | 3.1 | 3.5 |
| | resistance | | | | | | | | | |

| | | | Comparison examples | | | | | | |
|---|---|---|---|---|---|---|---|---|---|
| | | unit | 1 | 2 | 3 | 4 | 5 | 6 | 7 |
| Saturated | Items | | — | Stearic acid | | Succinic acid | | Paraffin | Silicone |
| Carboxylic | Content | % | 0.0 | 3.0 | 0.5 | 3.0 | 0.5 | 1.0 | 1.0 |
| acid | (in terms of solid | | | | | | | | |
| | content) | | | | | | | | |
| Wood | Freeness | ml | 500 | | 780 | 500 | 780 | 500 | |
| pulp | | | | | | | | | |
| Physical | Thickness | mm | 11.8 | 12.1 | 11.8 | 12.2 | 11.8 | 11.8 | 11.9 |
| Property | Specific gravity | | 0.95 | 0.90 | 0.92 | 0.84 | 0.93 | 0.96 | 0.94 |
| of board | Moisture content | % | 9.1 | 9.0 | 8.2 | 6.3 | 8.7 | 9.2 | 9.9 |
| | Bending strength | N/mm² | 13.5 | 10.9 | 12.5 | 9.8 | 12.9 | 8.6 | 10.3 |
| | Young's modulus | kN/mm² | 3.9 | 2.1 | 3.1 | 1.9 | 2.9 | 1.8 | 2.2 |
| | in flexure | | | | | | | | |
| | Maximum amount | mm | 11.8 | 22.1 | 12.4 | 25.3 | 12.7 | 16.8 | 18.2 |
| | of deflection | | | | | | | | |
| | Amount of surface | g/m² | 4,500 | 960 | 3,120 | 840 | 3,040 | 1,210 | 1,070 |
| | water absorption | | | | | | | | |
| | Elongation | % | 0.16 | 0.12 | 0.14 | 0.18 | 0.15 | 0.29 | 0.31 |
| | percentage by | | | | | | | | |
| | water absorption | | | | | | | | |
| | Shrinkage | % | 0.25 | 0.38 | 0.31 | 0.45 | 0.26 | 0.32 | 0.43 |
| | percentage by | | | | | | | | |
| | releasing moisture | | | | | | | | |
| | Carbonation | % | 0.22 | 0.03 | 0.14 | 0.05 | 0.11 | 0.33 | 0.28 |
| | shrinkage | | | | | | | | |
| | percentage | | | | | | | | |
| | Freezing thawing | % | 12.0 | 25.8 | 11.0 | 28.9 | 18.2 | 27.4 | 21.3 |
| | resistance | | | | | | | | |

In producing the inorganic board of Example 1, a refined wood pulp with freeness of 500 ml and a stearic acid emulsion solution were used, wherein the stearic acid emulsion solution was added to the slurry so that the stearic acid accounted for 0.5 weight % based on the total solid content of the slurry, which, as shown in Table 1, provided an inorganic board with no problem in the properties such as specific gravity, moisture content, bending strength, Young's modulus in flexure, maximum amount of deflection, and shrinkage percentage by releasing moisture; and was excellent in the properties such as amount of surface water absorption, elongation percentage by water absorption, carbonation shrinkage percentage, and freezing thawing resistance. Also, almost no stearic acid was found in the water which drained off during dehydration.

In producing the inorganic board of Example 2, a refined wood pulp with freeness of 500 ml and a stearic acid emulsion solution were used, wherein the stearic acid emulsion solution was added to the slurry so that the stearic acid accounted for 1.0 weight % based on the total solid content of the slurry, which, as shown in Table 1, provided an inorganic board with no problem in the properties such as specific gravity, moisture content, bending strength, Young's modulus in flexure, maximum amount of deflection, and shrinkage percentage by releasing moisture; and was excellent in the properties such as amount of surface water absorption, elongation percentage by water absorption, carbonation shrinkage percentage, and freezing thawing resistance. Also, almost no stearic acid was found in the water which drained off during dehydration.

In producing the inorganic board of Example 3, a refined wood pulp with freeness of 500 ml and a stearic acid emulsion solution were used, wherein the stearic acid emulsion solution was added to the slurry so that the stearic acid accounted for 2.0 weight % based on the total solid content of the slurry, which, as shown in Table 1, provides an inorganic board with no problem in the properties such as specific gravity, moisture content, bending strength, Young's modulus in flexure, maximum amount of deflection, and shrinkage percentage by releasing moisture; and was excellent in the properties such as amount of surface water absorption, elongation percentage by water absorption, carbonation shrinkage percentage, and freezing thawing resistance. Also, almost no stearic acid was found in the water which drained off during dehydration.

In producing the inorganic board in Example 4, a refined wood pulp with freeness of 500 ml, an unrefined wood pulp with freeness of 780 ml and a stearic acid emulsion solution were used, wherein the stearic acid emulsion solution was added to the slurry so that the stearic acid accounted for 2.0 weight % based on the total solid content of the slurry, which, as shown in Table 1, provided an inorganic board with no problem in the properties such as specific gravity, moisture content, bending strength, Young's modulus in flexure, maximum amount of deflection, and shrinkage percentage by releasing moisture; and was excellent in the properties such as amount of surface water absorption, elongation percentage by water absorption, carbonation shrinkage percentage, and freezing thawing resistance. Also, almost no stearic acid was found in the water which drained off during dehydration.

In producing the inorganic board in Example 5, a refined wood pulp with freeness of 500 ml and a succinic acid emulsion solution were used, wherein the succinic acid emulsion solution was added to the slurry so that the succinic acid accounted for 0.5 weight % based on the total solid content of the slurry, which, as shown in Table 1, provided an inorganic board with no problem in the properties such as specific gravity, moisture content, bending strength, Young's modulus in flexure, maximum amount of deflection, and shrinkage percentage by releasing moisture; and was excellent in the properties such as amount of surface water absorption, elongation percentage by water absorption, carbonation shrinkage percentage, and freezing thawing resistance. Also, almost no succinic acid was found in the water which drained off during dehydration.

In producing the inorganic board in Example 6, a refined wood pulp with freeness of 500 ml and a succinic acid emulsion solution were used, wherein the succinic acid emulsion solution was added to the slurry so that the succinic acid accounted for 1.0 weight % based on the total solid content of the slurry, which, as shown in Table 1, provided an inorganic board with no problem in the properties such as specific gravity, moisture content, bending strength, Young's modulus in flexure, maximum amount of deflection, and shrinkage percentage by releasing moisture; and was excellent in the properties such as amount of surface water absorption, elongation percentage by water absorption, carbonation shrinkage percentage, and freezing thawing resistance. Also, almost no succinic acid was found in the water which drained off during dehydration.

In producing the inorganic board in Example 7, a refined wood pulp with freeness of 500 ml and a succinic acid emulsion solution were used, wherein the succinic acid emulsion solution was added to the slurry so that the succinic acid accounted for 2.0 weight % based on the total solid content of the slurry, which, as shown in Table 1, provided an inorganic board with slightly low values in the properties such as specific gravity, moisture content, bending strength, and Young's modulus in flexure, but was excellent in the properties such as amount of surface water absorption, elongation percentage by water absorption, carbonation shrinkage percentage, and freezing thawing resistance. Also, almost no succinic acid was found in the water which drained off during dehydration.

In producing the inorganic board in Example 8, a refined wood pulp with freeness of 500 ml, an unrefined wood pulp with freeness of 780 ml and a succinic acid emulsion solution were used, wherein the succinic acid emulsion solution was added to the slurry so that the succinic acid accounted for 2.0 weight % based on the total solid content of the slurry, which, as shown in Table 1, provided an inorganic board with no problem in the properties such as specific gravity, moisture content, bending strength, Young's modulus in flexure, and shrinkage percentage by releasing moisture; and was excellent in the properties such as amount of surface water absorption, elongation percentage by water absorption, carbonation shrinkage percentage, and freezing thawing resistance. Also, almost no succinic acid was found in the water which drained off during dehydration.

In producing an inorganic board in Comparison Example 1, a refined wood pulp with freeness of 500 ml was used but no saturated carboxylic acid emulsion solution was used, which, as shown in Table 1, provided an inorganic board with no problem in the properties such as specific gravity, moisture content, bending strength, Young's modulus in flexure, maximum amount of deflection, and shrinkage percentage by releasing moisture; but was poor in the properties such as amount of surface water absorption, elongation percentage by water absorption, carbonation shrinkage percentage, and freezing thawing resistance.

In producing an inorganic board in Comparison Example 2, a refined wood pulp with freeness of 500 ml and a stearic acid emulsion solution were used, wherein the stearic acid emulsion solution was added to the slurry so that the stearic acid accounted for 3.0 weight % based on the total solid content of the slurry, which, as shown in Table 1, provided an inorganic board excellent in the properties such as amount of surface water absorption, elongation percentage by water absorption, and carbonation shrinkage percentage, but was poor in the properties such as, bending strength, Young's modulus in flexure, maximum amount of deflection, shrinkage percentage by releasing moisture and freezing thawing resistance. Also, stearic acid was found in the water which drained off during dehydration.

In producing an inorganic board in Comparison Example 3, an unrefined wood pulp with freeness of 780 ml and a stearic acid emulsion solution were used, where the stearic acid emulsion solution was added to the slurry so that the stearic acid accounted for 0.5 weight % based on the total solid content of the slurry, which, as shown in Table 1, provided an inorganic board with no problem in the properties such as specific gravity, moisture content, Young's modulus in flexure, and maximum amount of deflection, but was slightly poor in bending strength, and poor in the properties such as amount of surface water absorption, elongation percentage by water absorption, shrinkage percentage by releasing moisture, carbonation shrinkage percentage, and freezing thawing resistance. Also, stearic acid was found in the water which drained off during dehydration.

In producing an inorganic board in Comparison Example 4, a refined wood pulp with freeness of 500 ml and a succinic acid emulsion solution were used, wherein the succinic acid emulsion solution was added to the slurry so that the succinic acid accounted for 3.0 weight % based on the total solid content of the slurry, which, as shown in Table 1, provided an inorganic board excellent in the properties such as amount of surface water absorption, and carbonation shrinkage percentage, but was poor in the properties such as specific gravity, bending strength, Young's modulus in flexure, maximum amount of deflection, elongation percentage by water absorption, shrinkage percentage by releasing moisture and freezing thawing resistance. Also, succinic acid was found in the water which drained off during dehydration.

In producing an inorganic board in Comparison Example 5, an unrefined wood pulp with freeness of 780 ml and a succinic acid emulsion solution were used, wherein the stearic acid emulsion solution was added to the slurry so that the succinic acid accounted for 0.5 weight % based on the total solid content of the slurry, which, as shown in Table 1, provided an inorganic board with no problem in the properties such as specific gravity, moisture content, bending strength, Young's modulus in flexure, maximum amount of deflection, and Shrinkage percentage by releasing moisture; but was poor in the properties such as amount of surface water absorption, elongation percentage by water absorption, carbonation shrinkage percentage, and freezing thawing resistance. Also, succinic acid was found in the water which drained off during dehydration.

In producing an inorganic board in Comparison Example 6, a refined wood pulp with freeness of 500 ml and a paraffin solution were used, wherein the paraffin solution was added to the slurry so that the paraffin accounted for 1.0 weight % based on the total solid content of the slurry, which, as shown in Table 1, provided an inorganic board excellent in amount of surface water absorption, but was poor in the properties such as bending strength, Young's modulus in flexure, maximum amount of deflection, elongation percentage by water absorption, shrinkage percentage by releasing moisture, carbonation shrinkage percentage, and freezing thawing resistance. Also, paraffin was found in the water which drained off during dehydration.

In producing an inorganic board in Comparison Example 7, a refined wood pulp with freeness of 500 ml and a silicone emulsion solution were used, wherein the silicone emulsion solution was added to the slurry so that the silicone accounted for 1.0 weight % based on the total solid content of the slurry, which, as shown in Table 1, provided an inorganic board excellent in amount of surface water absorption, but was poor in the properties such as bending strength, Young's modulus in flexure, elongation percentage by water absorption, shrinkage percentage by releasing moisture, carbonation shrinkage percentage, and freezing thawing resistance. Also, silicone was found in the water which drained off during dehydration.

As described above, in the inorganic board of the present invention, water absorption, dimensional change and/or carbonation shrinkage can be suppressed, and water absorption resistance, dimensional stability and/or frost damage resistance can be secured for a long time. Also the producing method of the present invention can be carried without having large facilities, therefore, an initial investment and running costs can be very small in addition to only requiring simple operations. Further, the production can be carried out without trouble and it was found that even a small amount of carboxylic acid can work well.

What is claimed is:

1. An inorganic board comprising;
a cement-based hydraulic material,
a refined fiber reinforcing material, and
a saturated carboxylic acid.

2. The inorganic board according to claim 1, wherein the refined fiber reinforcing material is in a concentration of 1 weight % to 30 weight % based on the total weight of the dried solid content of the inorganic board.

3. The inorganic board according to claim 1, wherein the saturated carboxylic acid is in a concentration of 0.1 weight % to 2.0 weight % based on the total weight of the dried solid content of the inorganic board.

4. The inorganic board according to claim 3, wherein the saturated carboxylic acid is a stearic acid-based carboxylic acid or a succinic acid-based carboxylic acid.

5. The inorganic board according to claim 1, wherein the cement-based hydraulic material is at least one selected from the group consisting of Portland cement, mixed cement, eco-cement, low heat cement, and alumina cement.

6. The inorganic board according to claim 1, wherein the refined fiber reinforcing material is an inorganic fiber and/or organic fiber.

7. The inorganic board according to claim 1, wherein the refined fiber reinforcing material is at least one selected from the group consisting of waste paper, wood pulp, wood fiber bundle, wood fiber, wood chip, wood wool, wood flour, wollastonite, glass fiber, carbon fiber, polyamide fiber, polypropylene fiber, polyvinyl alcohol fiber, polyester fiber and polyethylene fiber.

8. The inorganic board according to claim 1, wherein the refined fiber reinforcing material is in a concentration of 1 weight % to 30 weight % and the saturated carboxylic acid is in a concentration of 0.1 weight % to 2.0 weight % based on the total weight of the dried solid content of the inorganic board.

9. The inorganic board according to claim 1, wherein the refined fiber reinforcing material is in a concentration of 1 weight % to 30 weight %, the saturated carboxylic acid is in a concentration of 0.1 weight % to 2.0 weight % based on the total weight of the dried solid content of the inorganic board, and the saturated carboxylic acid is a stearic acid-based carboxylic acid or a succinic acid-based carboxylic acid.

10. The inorganic board according to claim 1, wherein the saturated carboxylic acid is a stearic acid-based carboxylic acid or a succinic acid-based carboxylic acid.

11. A method for producing an inorganic board comprising steps of:
preparing a slurry by dispersing a cement-based hydraulic material and a refined fiber reinforcing material into water,
adding a saturated carboxylic acid to the slurry, and then
forming the slurry into a sheet,
dehydrating the sheet,
pressing the sheet and
curing the sheet.

12. The method according to claim 11, wherein the saturated carboxylic acid is a stearic acid-based carboxylic acid or a succinic acid-based carboxylic acid.

13. The method according to claim 11, wherein the refined fiber reinforcing material is in a concentration of 1 weight % to 30 weight % based on the total weight of the dried solid content of the inorganic board.

14. The method according to claim 11, wherein the saturated carboxylic acid is in a concentration of 0.1 weight % to 2.0 weight % based on the total weight of the dried solid content of the inorganic board.

15. The method according to claim 14, wherein the saturated carboxylic acid is a stearic acid-based carboxylic acid or a succinic acid-based carboxylic acid.

16. The method according to claim 11, wherein the cement-based hydraulic material is at least one selected from the group consisting of Portland cement, mixed cement, eco-cement, low heat cement, and alumina cement.

17. The method according to claim 11, wherein the refined fiber reinforcing material is an inorganic fiber and/or organic fiber.

18. The method according to claim 11, wherein the refined fiber reinforcing material is at least one selected from the group consisting of waste paper, wood pulp, wood fiber bundle, wood fiber, wood chip, wood wool, wood flour, wollastonite, glass fiber, carbon fiber, polyamide fiber, polypropylene fiber, polyvinyl alcohol fiber, polyester fiber and polyethylene fiber.

19. The method according to claim 11, wherein the refined fiber reinforcing material is in a concentration of 1 weight % to 30 weight % and the saturated carboxylic acid is in a concentration of 0.1 weight % to 2.0 weight % based on the total weight of the dried solid content of the inorganic board.

20. The method according to claim 11, wherein the refined fiber reinforcing material is in a concentration of 1 weight % to 30 weight %, the saturated carboxylic acid is in a concentration of 0.1 weight % to 2.0 weight % based on the total weight of the dried solid content of the inorganic board, and the saturated carboxylic acid is a stearic acid-based carboxylic acid or a succinic acid-based carboxylic acid.
